(19) United States
(12) Patent Application Publication
(10) Pub. No.: US 2012/0290689 A1
(43) Pub. Date: Nov. 15, 2012

(54) Network Interface Auto Configuration of Wireless Devices

(76) Inventors: Adam Beguelin, Incline Village, NV (US); Yacin Bahi, Los Altos, CA (US); Thomas Sheffler, San Francisco, CA (US)

(21) Appl. No.: 13/107,937

(22) Filed: May 15, 2011

(51) Int. Cl. G06F 15/177

(52) U.S. Cl. 709/220

(57) ABSTRACT

The invention described herein covers methods, apparatus and systems for auto configuring a wireless electronic device, such as an IP camera, to communicate with a wireless network, such as a home WiFi network router.

### FIELD

The present invention relates to simplified methods and systems for configuring wireless electronic devices, for example and not by way of limitation IP cameras, to communicate with a network.

### INCORPORATION BY REFERENCE

All publications and patent applications mentioned in this specification are incorporated herein, in their entirety, by reference to the same extent as if each individual publication or patent application was specifically and individually indicated to be incorporated by reference.

### BACKGROUND

Connecting a wireless electronic device, for example and not by way of limitation an IP camera, to a network requires a user to configure the device by inputting configuration data such as an IP address, WEP code or other encrypted passwords and SSID into the device to enable it to communicate with the network. For ease of description and not by way of limitation this specification will use IP camera to represent the wireless electronic device. The current state of the art for network IP camera configuration involves an ad hoc multistep process. Discovering and assigning or setting the IP camera's configuration information (e.g., network IP address, network WEP or other passwords, SSID and the like) can be problematic. Typically, a user installs software provided by the IP camera manufacturer onto a computer, hard wires the IP camera to the network, the computer software then finds the IP camera permitting the user to enter, save and set the network configuration information on the IP camera (e.g., network IP address, network WEP or other passwords, and SSID), and then the user disconnects the IP camera from the wired network. The configured IP camera may now wirelessly communicate with the network. Alternatively, if the camera has an ethernet connection, then standard protocols like DHCP can be used by the camera to obtain the network configuration information when the network cable is connected. If the camera is wireless, then DHCP is not sufficient, as the camera also needs to know the wireless network name and any security settings for that network.

Alternatively, a network camera could be configured with a user input device that would allow the user to configure the camera directly by manually inputting the configuration information. For example, a multitouch display would allow the user to configure the camera directly without requiring the camera to be connected to a wired network first, but would require the user to obtain the necessary configuration information from the network using, e.g., a computer.

### BRIEF DESCRIPTION OF THE DRAWINGS

FIG. 1 represents an exemplary autoconfiguration system in accordance with one embodiment of the present invention; and

FIG. 2 represents a method flow for autoconfiguring an IP camera in accordance with one embodiment of the present invention.

### DETAILED DESCRIPTION

In the following description and in the accompanying drawings, specific terminology and reference numbers are set forth to provide a thorough understanding of the present invention. In some instances, the terminology and symbols may imply specific details that are not required to practice the invention. The Sensr Net Audio Camera Configuration (SNACC) is a mechanism for configuring wireless network devices, also referred to herein as IP cameras for simplicity of description. This description uses “IP camera” to facilitate describing the present invention and not by way of limitation; the present invention is equally applicable to any wireless electronic devices capable of connecting to a network. This description also uses WiFi network for ease of explanation, but the invention is applicable to any network capable of wirelessly communicating or connecting to the IP camera, for example and without limitation mobile phone or other wireless networks. It will be appreciated by the skilled artisan that the present invention can be used to further configure an already configured electronic device (wired or wireless) to provide the device with further communication capabilities, such as the ability to communicate with a web site. Typically IP cameras are difficult to configure, particularly for wireless networks. Embodiments of the present invention make configuring the IP camera much easier than existing mechanisms and methods, and enables simplified camera designs.

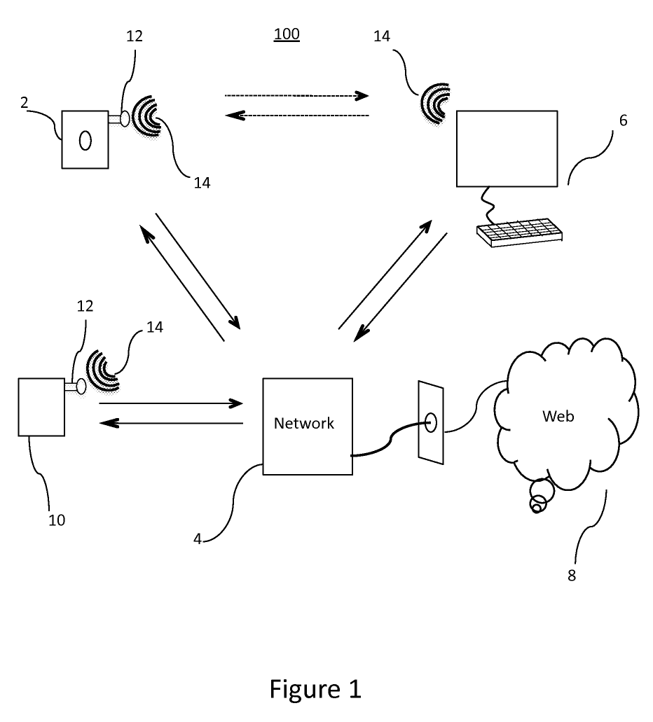

FIG. 1 illustrates a system 100 for automatically configuring IP camera 2 or other wireless device 10 enabling it to connect wirelessly to network 4. Once connected to network 4, IP camera 2 may also communicate wirelessly through network 4 with computer 6 or web 8, where computer 6 and web 8 are also able to communicate with IP camera 2 via network 4. Also shown is other wireless device 10, e.g. and not by way of limitation, for receiving streamed music from computer 6 through network 4 such as (for example and not by way of limitation) the Airport Express® by Apple Inc. In this particular example, network 4 may be the Airport Extreme®, a home wireless WiFi router, by Apple Inc.

Computer 6, or software on it in conjunction with a processor, encodes the configuration information into audio encoded configuration information 14, and transmits it via a speaker (not shown) to microphone 12 on IP camera 2 or other wireless device 10. Audio encoding is well known to the skilled artisan and will not be further explained here, other than to mention any form of audio encoding falls within the scope of the invention so long as the information can be read and decoded by a receiving device. Computer 6 obtains audio encoded configuration information 14 by any number of known mechanisms. For example, and not by way of limitation, a user points a web browser, on computer 6 and via network 4, to a web site and downloads the configuration information, or alternatively manually transfers (e.g., by typing) the configuration information from the web site to computer 6, and software on computer 6 encodes the configuration information to an audio file, or alternatively but less preferred a user simply manually inputs the information into computer 6 from manufacturer provided information and the computer audio encodes the information. Alternatively, the user points to a website maintained by the manufacturer or by a software as a service site such as Sensr.Net. On the site, the user enters information about the local network, such as the network gateway, SSID, and WEP password. The website then generates a webpage for the user containing the configuration information along with audio encoded configuration information, the webpage not being necessary, where the user can select to broadcast the encoded information, save it for later broadcast or both. In another example the user logs into the network router using a web browser, and selects an ‘add camera’ option from the router's configuration pages. The add camera button, in accordance with this embodiment of the invention, is a button built into the configuration page of the network router, which when selected would build the configuration files necessary to configure devices that would communicate more seamlessly with the router. The network router then allocates an IP address for the IP camera and generates a configuration web page for the IP camera, which would include audio encoded configuration information, again the web page not being necessary. In another alternative embodiment, the web site, to which the computer's web browser is pointed, has code or a script, activated or selected by the computer user, which transmits the audio encoded configuration information to computer 6.

A user then directs computer 6 to transmit the audio coded configuration information through any of a number known sound emitting devices. For example and not by way of limitation, the audio encoded information can be transmitted by speakers, or a call to a cell phone from a web service that transmits the encoded information through the phone. The skilled artisan will recognize many different mechanisms for transmitting the audio encoded information. This description has used computer 6 as an example of a device that can receive code and emit audio encoded configuration information. The skilled artisan will recognized the invention is not so limited. More than one device may be used to perform these functions. For example and without limitation, any device capable of obtaining and/or transmitting audio encoded information may be used, and preferably a device capable of having the audio encoded information stored on it may be used to either obtain and encode the configuration information and/or transmit audio encoded configuration information. Examples include, not by way of limitation, a CD or other optical disk, tape recorder, telephone, mobile phone, PDA or the like.

IP camera 2 has a microphone 12, or other sound receiving device as may be known to the skilled artisan, for receiving audio encoded configuration information 14. Software and/or a processor and/or firmware (i.e. “software”) on IP camera 2 listens for the audio encoded configuration information 14, and, after recognizing it, decodes it into configuration information. The same or separate software uses the configuration information to configure the network interface (not shown) of IP camera 2 enabling it to communicate with network 4. The skilled artisan will appreciate how the IP camera uses the configuration information to enable or configure the camera to communicate with the network, for example and not by way of limitation the camera processor or code thereon would store the configuration information in an appropriate file to be accessed by the processor or other appropriate hardware or firmware in order to properly communicate with the network. The skilled artisan will further appreciate that software and/or processor for listening to and decoding audio encoded information presently exist, and that any such software and/or processor will fall within the scope of embodiments of the present invention. In an alternative embodiment, IP camera 2 runs code, script or a process to listen for audio encoded configuration information when activated to do so, for example and not by way of limitation by the user pushing a button, turning the camera power on, resetting the camera to factory settings or the like. Configuration information may include, without limitation, the network IP address, SSID, WEP or other encrypted password (e.g., WPA, WPA2, TKIP, AES, WPA personal, WPA enterprise), DNS server settings, and IP gateway settings, port forwarding information as well as any other configuration information necessary for IP camera 2 to communicate with the wireless network, any devices connected to the wireless network, or connect to a web site or service on the web via the IP camera's connection to the wireless network. An advantage of the present invention is that the audio encoded configuration information can be transmitted to the microphone over relatively long distances, and into hard to reach spaces. For example, the IP camera may be mounted on a ceiling or in a hard to reach corner. Using embodiments of the present invention, the IP camera can be configured to communicate with the network without hard wiring the camera (either by unmounting or running a wire to the hard to reach camera) or dismounting the camera. The user simply transmits the audio encoded configuration information from a transmitting device to the camera such that the camera can hear it, and the software on the camera will atomically configure its network interface with the transmitted audio encoded configuration information. A further benefit includes an ability to manufacture more compact IP cameras that do not require all the wiring presently necessary to configure the IP cameras, e.g., Ethernet connections and wiring. A further advantage is the ability of the IP camera to eliminate the need for port forwarding in order to access the IP camera from outside a network firewall. There are ports on the IP camera that can be configured and ports on the wireless network and the mapping between these is called port forwarding. Port forwarding is needed if the IP camera is not connecting to a service or web site outside the network firewall. The problem with port forwarding is that it is complex and it allows others get through the firewall. Embodiments of the present invention eliminate the need for port forwarding.

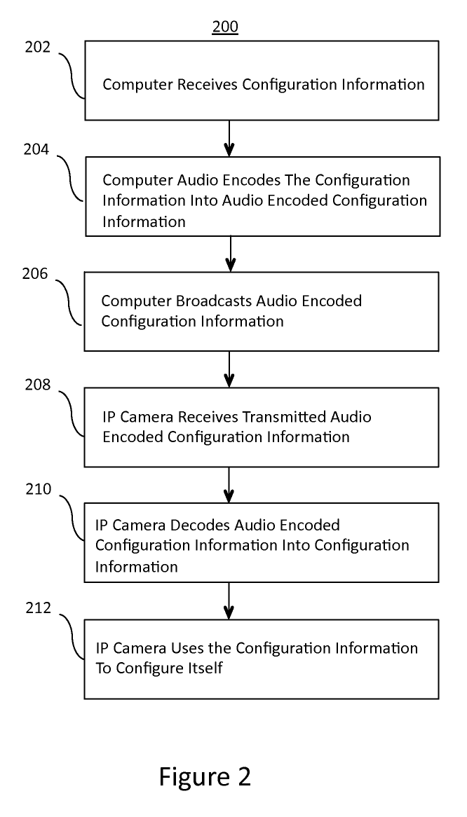

FIG. 2 illustrates an exemplary method 200 for autoconfiguring IP camera 12 or other wireless electronic device. In step 202 a computer or other device receives configuration information, in step 204 it encodes the configuration information into audio encoded configuration information, and in step 204 the computer broadcasts the audio encoded information. As described above, the present invention is not limited to using a computer, and the skilled artisan will recognize many other ways to obtain and transmit the audio encoded configuration information. In step 208 the IP camera (or other wireless device) receives the transmitted audio encoded configuration information via some known audio receiving device, such as a microphone. In step 210 the IP camera decodes the audio encoded configuration information into configuration information needed, at least in part, for the IP camera to communicate with a network. In addition, and as described above, the configuration information may also include information needed by the IP camera to push information out into the internet and be accessed or viewed by any computer or device having access to the internet. In step 212, the IP camera, or software on the IP camera uses the decoded configuration information to configure itself, e.g. and not by way of limitation, set the network IP address, WEP or other encrypted password to access the network, and SSID such that the IP camera may communicate with the network, and optionally to push information onto the internet via the network. The skilled artisan will recognize many ways for the camera to configure itself to communicate with the network. For example, and not by way of limitation the camera (software or firmware thereon) stores the configuration information into an appropriate file from which the configuration information is used to communicate with the network.

The skilled artisan will recognize many ways to utilize embodiments of the present invention to configure IP cameras and other wireless devices. The following examples are given by way of example and not limitation. The user could purchase network router preconfigured with an SSID and encrypted password. A computer or phone communicating with the network router obtains the configuration information from the network router, encodes the information into audio encoded configuration information, and broadcasts the audio encoded information. The IP camera then receives the audio encoded information, translates it and uses the resulting configuration information to configure the IP camera, as previously described. In this example the IP camera does not have a specific IP address but would use the SSID and WEP password to connect to the network and get an IP address using the standard DHCP protocol.

In another example the user logs into the network browser using a web browser, and selects an ‘add camera’ option from the router's configuration pages. The network router then allocates an IP address for the IP camera and generates a configuration web page for the IP camera, which would include audio encoded configuration information. The audio encoded configuration information is then broadcast by the computer or other device accessing the web page, and the IP camera receives and translates the audio encoded configuration information, and configures itself as previously described. The advantage of this example is that the IP address of the IP camera can be displayed in the web page for the user. The user can also specify other configuration information in the router page as well, such as a name for the IP camera or a specific IP address should the user wish to statically allocate the IP address and other settings for the IP camera.

In another example the user buys an IP camera from a specific manufacturer, such as Sony. The user then goes to a website maintained by the manufacturer to configure the IP camera. On the manufacturer's site, the user enters information about the local network, such as the network gateway, SSID, and WEP password. The website then generates a webpage for the user containing the configuration information along with audio encoded configuration information. The computer or device accessing the web page transmits the audio encoded configuration information to the IP camera, and the IP camera configures itself as previously explained. In all these examples an audio back up file can be saved for reconfiguring the IP camera in the event a reconfiguration becomes necessary.

In a final example, a user can carry the IP camera to a remote location having a network to which the user wants to connect the IP camera, a coffee shop for example. The user could connect his laptop or other device (mobile phone for example) to the cafe's network and run a program to display or obtain the network configuration information, e.g., the cafe's wifi information, and encode it into audio encoded configuration information. The user then transmits the audio encoded configuration information to the IP camera, and the IP camera configures itself to communicate with the network as previously described. This gives the ability of the user to configure the IP camera or other wireless device at any location without the hassle of manually inputting the information or hardwiring the device to the network. If the IP camera is small enough and battery operated, the user could leave the IP camera or other wireless device and access it remotely through the internet.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” includes, without limitation, any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein does not require the particular order shown, or sequential order, to achieve desirable results. Other embodiments may be within the scope of the following claims.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A wireless electronic device comprising:
a microphone;
program code stored in computer accessible memory that, when executed, translates audio data received from said microphone into configuration information and configures said wireless electronic device, using said configuration information, to communicate with a network.

2. The wireless electronic device of claim 1, wherein said wireless electronic device comprises an IP camera, a phone, a video camera, a digital camera, or a computer.

3. The wireless electronic device of claim 1, wherein said configuration information comprises WPA, TKIP, AES, DNS settings SSID, WEP data and an encoded password or combinations thereof.

4. The wireless electronic device of claim 3, wherein said configuration information further comprises a web address password, and wherein said program code, when executed, uses said web address password to connect to the web address and enable pushing of data from the wireless electronic device to the web address, thereby enabling access to said data from any computer capable of connecting to the web address.

5. The wireless electronic device of claim 1, wherein said network comprises a WiFi network, mobile phone network, wired networks, or wireless networks.

6. A system for configuring a wireless electronic device to communicate with a network, the system comprising:
a first device for transmitting audible coded configuration information;
a microphone connected to said wireless electronic device for receiving said audible coded configuration information;
one or more software programs stored in accessible memory on said wireless device, wherein said one or more software programs, when executed, translates said audible coded configuration information into translated configuration information, and configures said wireless electronic device to communicate with said network using said translated configuration information.

7. The wireless electronic device of claim 6, wherein said configuration information comprises WPA, TKIP, AES, DNS settings SSID, WEP data and an encoded password or combinations thereof.

8. The system according to claim 7, wherein said first device comprises a mechanism for obtaining configuration data for configuring the wireless electronic device, and code that, when executed, converts said configuration information into said audible coded configuration information.

9. The system according to claim 8, wherein said mechanism comprises a manual entry mechanism for entering said configuration data.

10. The system according to claim 8, wherein said mechanism comprises obtaining said configuration data electronically.

11. The system according to claim 10, wherein obtaining said configuration data electronically further comprises reading said configuration data from a memory device or reading said configuration information from a web address.

12. A method for remotely configuring a wireless electronic device to communicate with a network, the method comprising:
receiving audible coded configuration data by said wireless electronic device;
translating said audible coded configuration information into translated configuration information;
configuring said wireless electronic device to communicate with said network.

13. The method of claim 12, wherein said wireless device is an IP camera.

14. The method of claim 12, wherein said configuration information comprises WPA, TKIP, AES, DNS settings SSID, WEP data and an encoded password.

15. The method of claim 14, wherein said configuration information further comprises a web address password, and wherein said program code, when executed, uses said web address password to connect to the web address and enables pushing of data from the wireless electronic device to the web address, thereby enabling access to said data from any computer capable of connecting to the web address.

16. The wireless electronic device of claim 12, wherein said network comprises a WiFi network, mobile phone network, wired networks, or wireless networks.
